(19) United States
(12) Patent Application Publication
(10) Pub. No.: US 2009/0108013 A1
(43) Pub. Date: Apr. 30, 2009

(54) TEST STRIP EJECTION MECHANISM

(76) Inventors: Martijn Nisse Van Der Velde, Monza (IT); Jerry Pugh, Santa Rosa, CA (US); Aaron Ogilvie, San Ramon, CA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/257,445

(22) Filed: Oct. 24, 2008

Related U.S. Application Data
(60) Provisional application No. 60/982,796, filed on Oct. 26, 2007.

(51) Int. Cl. G07F 11/00

(52) U.S. Cl. 221/1; 221/208

(57) ABSTRACT

The present invention is directed to a test strip ejection mechanism for ejecting test strips from a test meter. The test strip mechanism includes a pusher assembly having at least one fin and a plurality of spaced apart test strip connectors configured to contact to a plurality of contact pads disposed on a test strip, wherein the fin pushes in between adjacent test strip connectors and against a proximal end of the test strip until the test strip is ejected.

A test meter can use a test strip for measuring an analyte in a physiological fluid such as blood. For example, the test meter and the test strip can be used for an electrochemical blood glucose measurement by people with diabetes. After a measurement is performed, the used test strip should be removed before another measurement can be performed. Blood may get on a user's finger when manually removing a test strip, which may not only be unpleasant, but can also create a risk of cross-contamination where the user's blood is transferred to another person. In addition, the risk of cross-contamination can be even higher in a hospital setting where a user tests several patients using the same test meter. Therefore, applicants believe that it is desirable to minimize user interaction with the used test strip so that the risk of cross-contamination is reduced.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a simplified plan view of a test strip connected to a test meter;

FIG. 2 is a simplified side view of the test meter of FIG. 1 without a test strip in place;

FIG. 3 illustrates a plan view of the test strip illustrated in FIG. 1;

FIG. 4 is a simplified block diagram of a kit for determining an analyte in a physiological fluid sample;

FIGS. 5A through 5C are simplified depictions of a user discarding a used test strip using a test strip ejection mechanism according to the present invention;

FIG. 6 is a top exploded perspective view of an unassembled test strip ejection mechanism according to one embodiment of the present invention;

FIG. 7 is a top exploded perspective view of an unassembled lower portion of a test strip ejection mechanism according to one embodiment of the present invention;

FIG. 8 is a simplified top perspective view of a test strip ejection mechanism during an initial state with an inserted test strip according to one embodiment of the present invention;

FIG. 9 is a simplified top perspective view of a test strip ejection mechanism according to one embodiment of the present invention where the test strip is in the process of being ejected;

FIG. 10 is a simplified top perspective view of a test strip ejection mechanism according to one embodiment of the present invention after ejecting the test strip;

FIG. 11 is a simplified top plan view of the test strip connectors, the guiding slots, and the fins according to one embodiment of the present invention;

FIG. 12 is a simplified front plan view of the test strip connectors, the guiding slots, and the fins according to one embodiment of the present invention;

FIG. 13 is a simplified side cross-sectional view of a test strip ejection mechanism according to one embodiment of the present invention in a first state where the test strip connectors contact with a top portion of the test strip;

FIG. 14 is a simplified side cross-sectional view of a test strip ejection mechanism according to one embodiment of the present invention in a second state where the test strip connectors contact with a top proximal edge of the test strip;

FIG. 15 is a simplified side cross-sectional view of a test strip ejection mechanism according to one embodiment of the present invention in a third state where the test strip connectors apply a propulsion force by snapping over the top proximal edge of the test strip;

FIG. 16 is a simplified side cross-sectional view of a test strip ejection mechanism according to one embodiment of the present invention in a fourth state where the test strip is in free flight from the test strip connector;

FIG. 17 is a top perspective view of a shim for use in a method of reforming test strip connectors according to an embodiment of the present invention;

FIG. 18 is a top perspective view of the shim of FIG. 17 about to be inserted into a strip port connector for reforming the test strip connectors according to a method of the present invention;

FIG. 19 is a top perspective view of the shim of FIG. 17 that has been inserted into the strip port connector for reforming the test strip connectors according to a method of the present invention; and

FIG. 20 is a perspective view of a reforming fixture for use in a method of reforming test strip connectors according to an alternative embodiment of the present invention where the reforming fixture has been mated with an upper portion of the strip port connector that is not attached to the printed circuit board (PCB).

### SUMMARY

The present invention is directed to a test strip ejection mechanism for ejecting test strips from a test meter. The test strip mechanism may include a pusher assembly having at least one fin and a plurality of spaced apart test strip connectors configured to contact to a plurality of contact pads disposed on a test strip, wherein the fin pushes in between adjacent test strip connectors and against a proximal end of the test strip until the test strip is ejected.

In an embodiment in accordance with the present invention, as set forth above, the test strip ejection mechanism may include a pusher assembly that advances the test strip so that the plurality of spaced apart test strip connectors snap over a proximal top edge of the test strip during the ejection process.

In an embodiment in accordance with the present invention, as set forth above, the test strip ejection mechanism may include a housing configured to substantially enclose the test strip ejection mechanism, wherein the pusher assembly does not extend beyond an exterior of the housing when deployed. In this embodiment the test strip ejection mechanism can eject the test strip without manually manipulating an orientation of the test strip ejection mechanism for facilitating an ejection. In this embodiment, the plurality of spaced apart test strip connectors can apply a force to the test strip, wherein the force may range from about 0.36 Newtons to about 0.84 Newtons.

In an embodiment in accordance with the present invention, as set forth above, the test strip ejection mechanism may include a lower portion and an upper portion where the plurality of spaced apart test strip connectors are disposed on the upper portion, and the pusher assembly is disposed on the lower portion. The test strip ejection mechanism may further include a substantially planar portion disposed in between the upper portion and the lower portion where the substantially planar portion has at least one slot configured to guide the at least one fin in between adjacent test strip connectors. The substantially planar portion may be a printed circuit board.

In an embodiment in accordance with the present invention, as set forth above, the test strip ejection mechanism may include a plurality of spaced apart test strip connectors that are configured to have a minimum gap distance with respect to the substantially planar portion, wherein the minimum gap may range from about 0% to about 60% of a test strip height. In another embodiment of this invention, the minimum gap may range from about 30% to about 60% of a test strip height. In yet another embodiment of this invention, the minimum gap may range from about 0.1 millimeters to about 0.2 millimeters.

In an embodiment in accordance with the present invention, as set forth above, the test strip ejection mechanism may include a pusher assembly having two fins configured to travel in between three adjacent test strip connectors.

In an embodiment in accordance with the present invention, as set forth above, the test strip ejection mechanism may include a pusher assembly operatively attached to a slideable button configured to move in a same direction as the test strip during an ejection. The test strip ejection mechanism may further include a biasing member for returning the pusher assembly to an initial state after ejecting the test strip.

In an embodiment in accordance with the present invention, as set forth above, the test strip ejection mechanism may include a pusher assembly that is floatably attached to the housing.

In a method of reforming a test strip connector in accordance with the present invention, the method may include providing a test strip connector, which has a minimum gap distance from a substantially planar portion, inserting a shim into the test strip connector so that the test strip connector is flexed in a first direction to a predetermined height coincident with a height of the shim, and removing the shim from the test strip connector allowing the test strip connector to relax in a second direction that opposes the first direction. As a result of inserting and removing the shim from the test strip connector, the minimum gap distance increased to a predetermined value compared to the initial minimum gap distance. In one embodiment of this method, the shim may have a predetermined height greater than the minimum gap distance before inserting the shim. In one embodiment of this method, the minimum gap distance after inserting the shim may range from about 0.1 millimeters to about 0.2 millimeters.

In an alternative method of reforming a test strip connector in accordance with the present invention, the method includes mating a reforming fixture with a test strip connector so that the test strip connector moves upward from a first position to a second position. The reforming fixture has an upper step and a lower step where the upper step is configured to push upwards against the test strip connector and the lower step is configured to push upwards against a lower portion of a bracket. The bracket is configured to hold the test strip connector. The reforming fixture is removed so that the test strip connector relaxes to a third position that is upwards from the first position. Next, a substantially planar portion is attached to the bracket so that a minimum gap distance is formed between the test strip connector and the substantially planar portion. In one embodiment of this method, the minimum gap distance may range from about 0.1 millimeters to about 0.2 millimeters.

In a method for ejecting a test strip in accordance with the present invention, the method may include actuating an ejection button that causes a pusher assembly to be deployed where the pusher assembly has at least one fin, moving the at least one fin in between a plurality of test strip connectors, pushing against a proximal end of the test strip with the at least one fin in an outward direction from a test meter while the test strip connectors touches a top surface of the test strip, continuing to advance the proximal end so that the test strip connectors touches a top proximal edge of the test strip, and snapping the test strip connectors over the top proximal edge of the test strip, which causes the test strip to be ejected from the test meter.

In a method for ejecting a test strip in accordance with the present invention, as set forth above, the method may further include test strip connectors that apply a test strip connector force substantially perpendicular to the top surface of the test strip when the test strip connector touches the top surface and does not touch the top proximal edge. In one embodiment of this method, the test strip connector force may range from about 0.36 Newtons to about 0.84 Newtons.

In a method for ejecting a test strip in accordance with the present invention, as set forth above, the method may further include a pusher assembly that applies a pusher force via the at least one fin that is greater than an opposing frictional force. The frictional force is proportional to a product of the test strip connector force that is substantially perpendicular to the top surface and a coefficient of friction between the test strip and the substantially planar portion.

In a method for ejecting a test strip in accordance with the present invention, as set forth above, the method may further include a test strip connector that may apply a test strip connector force sufficient to eject the test strip when the outward test strip connector force is greater than an opposing frictional force.

### DETAILED DESCRIPTION OF ILLUSTRATIVE EMBODIMENTS OF THE INVENTION

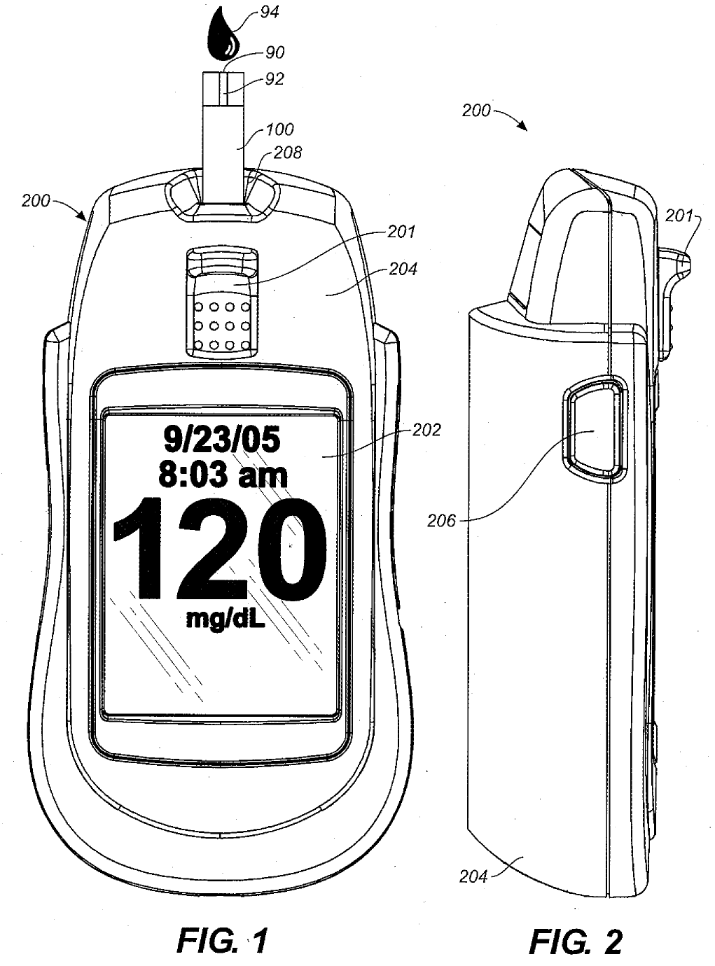

FIG. 1 is a simplified plan view of a test meter 200 and a test strip 100. Test meter 200 can include an ejection button 201, a visual display 202, a housing 204, a tutorial button 206, and a strip port connector 208, as shown in FIGS. 1 and 2. Test strip 100 can be inserted into strip port connector 208, as shown in FIG. 1. A blood sample 94 can be applied to an inlet 90 to fill a sample receiving chamber 92, as illustrated in FIG. 1, so that a measurement can be performed. Test meter 200 may also include suitable circuitry configured to determine whether a physiological sample has filled sample receiving chamber 92.

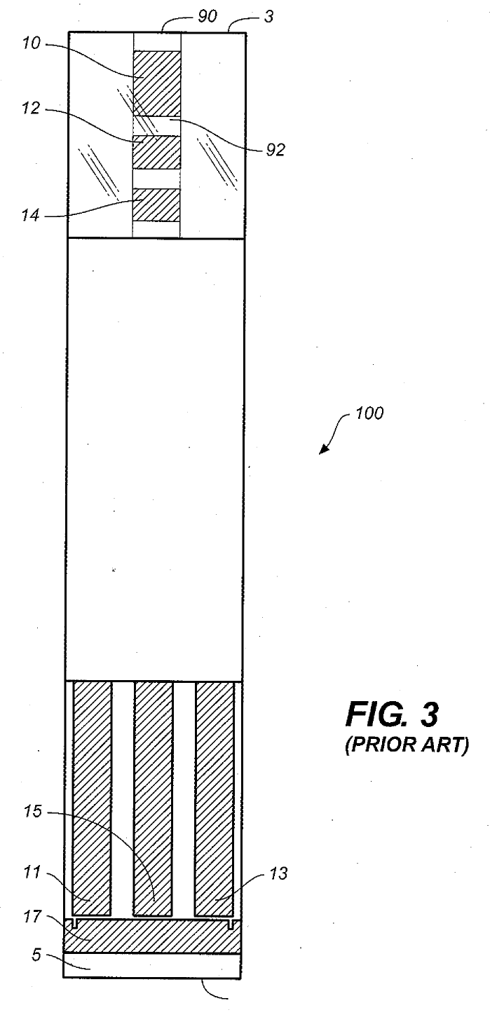

FIG. 3 illustrates a top plan view of test strip 100 that has a distal end 3 and a proximal end 4. Test strip 100 may include at least one working electrode and a reference electrode. More specifically, as illustrated in FIG. 3, test strip 100 includes a reference electrode 10, a first working electrode 12, and a second working electrode 14. Test strip 100 can further include a strip detection bar 17 disposed adjacent to proximal end 4. Strip detection bar 17 can be configured to turn test meter 200 on upon proper insertion of test strip 100 into test meter 200. A plurality of contact pads can be disposed at proximal end 4 and form an electrical connection to at least one working electrode and one reference electrode. In one embodiment, the plurality of contact pads can include a first contact pad 13, a second contact pad 15, and a reference contact pad 11, which are electrically connected to first working electrode 12, second working electrode 14, and reference electrode 10, respectfully. An example of a commercially available embodiment of a test strip is the OneTouch® Ultra® glucose test strip (Milpitas, Calif. 95035).

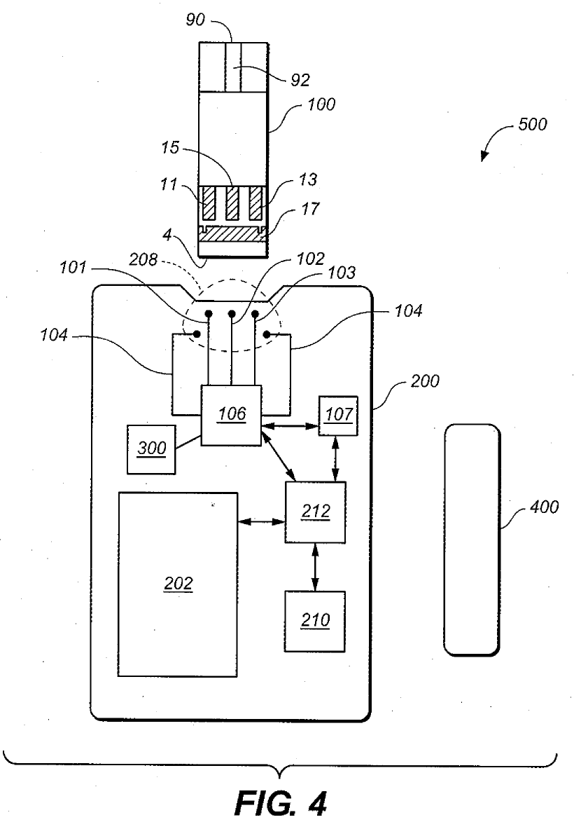

FIG. 4 illustrates a simplified schematic of a kit 500 that includes a test meter 200, a test strip 100, and a lancing device 400. Lancing device 400 can be configured to lance a fingertip for expressing a blood sample. Test meter 200 can include a strip port connector 208, a test voltage unit 106, a current measurement unit 107, a test strip ejection mechanism 300, a microprocessor unit 212, a memory unit 210, and a visual display 202. Housing 204 can be configured to substantially enclose strip port connector 208, test voltage unit 106, current measurement unit 107, test strip ejection mechanism 300, microprocessor unit 212, memory unit 210, and visual display 202.

Strip port connector 208 can be configured to receive proximal end 4 of test strip 100 and form an electrical connection with at least one working electrode and one reference electrode, as illustrated in FIG. 4. Strip port connector 208 can include a plurality of spaced apart test strip connectors configured to electrically connect to a corresponding plurality of contact pads. The plurality of spaced apart test strip connectors can include a reference connector 101, a second connector 102, and a first connector 103, and two strip-in-place connectors 104. Strip port connector 208 can form an electrical connection to reference contact pad 11, second contact pad 15, and first contact pad 13 via reference connector 101, second connector 102, and first connector 103, respectively. Additionally, strip port connector 208 can form an electrical connection to two points on strip detection bar 17 via two strip-in-place connectors 104. The plurality of test strip connectors (e.g., 101, 102, 103, and 104) can be made from an electrically conductive material suitable for carrying a current. The conductive material may be a gold plated beryllium/copper alloy or a gold plated phosphor bronze alloy. When selecting the conductive material for desirable properties, the test strip connectors can include a relatively low surface resistance to current, a high surface scratch resistance, and a high modulus of flexibility.

Test voltage unit 106 can include electronic circuitry configured to apply a first test voltage between first connector 103 and reference connector 101, and also a second test voltage between second connector 102 and reference connector 101, as illustrated in FIG. 4. Test voltage unit 106 may also be referred to as a potentiostat. Test voltage unit 106 can also communicate with a current measurement unit 107, strip-in-place connectors 104, and microprocessor unit 212.

Current measurement unit 107, as illustrated in FIG. 4, can include electronic circuitry configured to measure a magnitude of one or more test currents resulting from the application of a first test voltage and a second test voltage. Current measurement unit 107 can include a current-to-voltage converter and/or an analog-to-digital converter (A/D). Current measurement unit 107 can communicate with test voltage unit 106 and microprocessor unit 212.

Memory unit 210 can be any suitable memory unit known to those of skill in the art including, for example, a solid state nonvolatile memory (NVM) units or an optical disk-based memory unit, as illustrated in FIG. 4. In one embodiment, memory unit 210 may include both volatile and non-volatile memory portions. Memory unit 210 can be configured to contain software instructions to perform a glucose measurement using test meter 200 and test strip 100. Memory unit 210 can be configured to communicate with microprocessor 212.

Visual display 202 can be, for example, any suitable display screen known to those of skill in the art including a liquid crystal display (LCD) screen, as illustrated in FIG. 4. Visual display 202 can be used to illustrate a user interface for prompting a user on how operate test meter 200. Visual display 202 can also be used to perform other functions related to the operation of test meter 200 such as displaying a date, time, and glucose concentration value as depicted in FIG. 1.

Microprocessor unit 212 can be configured to control and operate a measurement of a physiological fluid with test meter 200 and test strip 100, as illustrated in FIG. 4. More specifically, microprocessor unit 212 can be operatively linked so as to control the function of test voltage unit 106, current measurement unit 107, visual display 202, and memory unit 210.

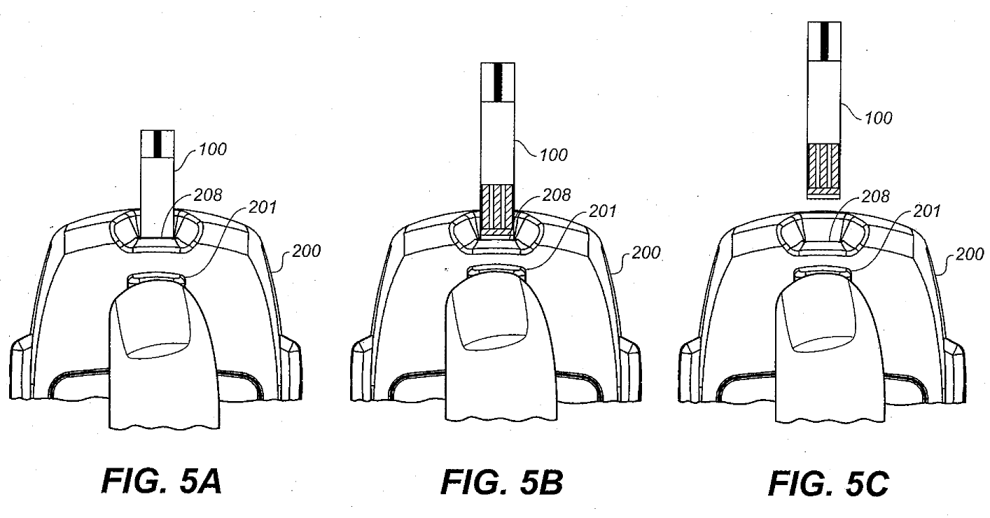

FIGS. 5A through 5C represent simplified depictions of a user discarding a used test strip using a test strip ejection mechanism according to one embodiment of the present invention. After an analyte measurement process has been performed, test strip 100 must be removed before another test strip 100 can be inserted into strip port connector 208. To initiate an ejection, a user can slide ejection button 201 forward, as indicated in FIGS. 5A through 5C. The motion of sliding ejection button 201 causes test strip 100 to be fully separated from test meter 200, as illustrated in FIG. 4C. Using the present invention, it is not necessary to wiggle test meter 200 or hold test meter 200 in a vertical manner to cause gravity to facilitate the ejection of test strip 100. After ejecting test strip 100, the user must insert a new test strip, as illustrated in FIG. 5A.

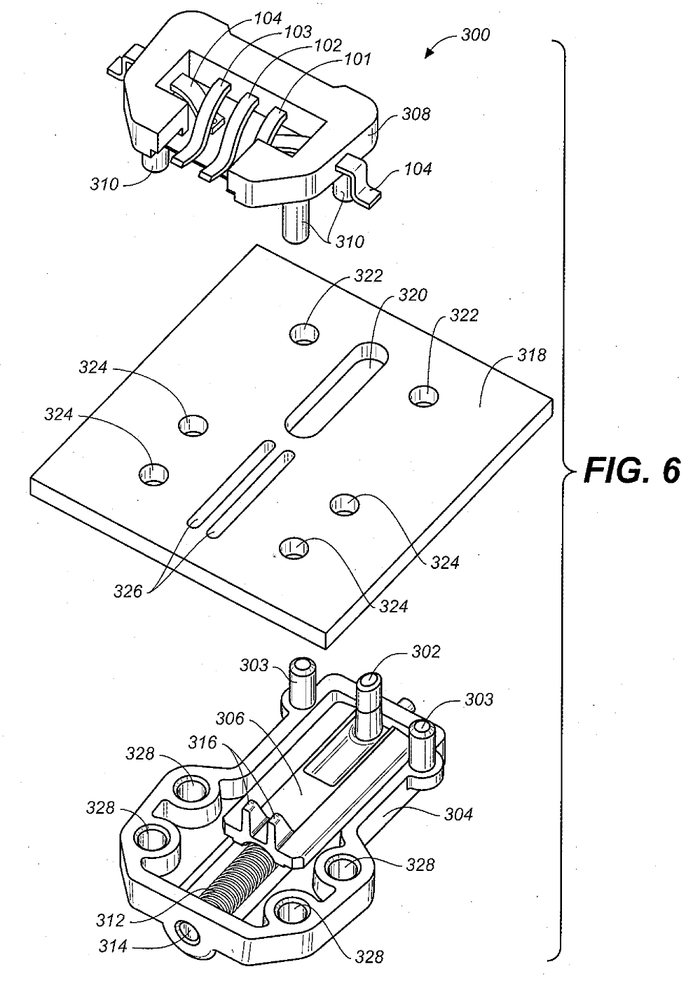

FIG. 6 is a top perspective view of a test strip ejection mechanism 300 that uses slideable ejection button 201 as previously described in FIGS. 5A to 5C. Test strip ejection mechanism 300 can include an upper portion 308, a printed circuit board (PCB) 318, and a lower portion 304. Note that PCB 318 may be referred to as a substantially planar portion. PCB 318 can be sandwiched in between upper portion 308 and lower portion 304 using a plurality of posts (302, 303, 310), through holes (322, 324), guiding slots (320, 326), and holes (328). Upper portion 308 includes four lower posts 310, which are guided by four corresponding through holes 324 disposed on PCB 318, as illustrated in FIG. 6. In turn, lower posts 310 can then become seated into four holes 328 on lower portion 304. Lower portion 304 includes two upper posts 303, which are guided by two corresponding through holes 322 disposed on PCB 318, as illustrated in FIG. 6.

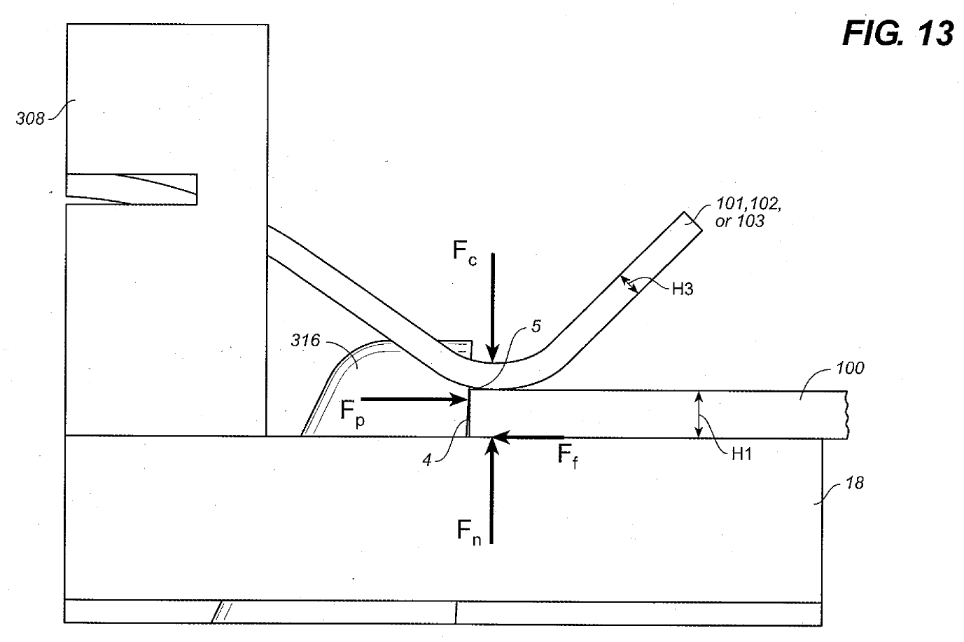

A plurality of spaced apart test strip connectors (101, 102, 103, 104) are disposed on upper portion 308, as illustrated in FIG. 6. Upper portion 308 can be in the form of a bracket for holding the test strip connectors (101, 102, 103, 104). The plurality of test strip connectors can include reference connector 101, second connector 102, first connector 103, and strip-in-place connectors 104. In addition to providing an electrical connection, the plurality of strip contacts (101, 102, 103, 104) are configured to apply a spring-like force of sufficient magnitude to substantially immobilize test strip 100, as illustrated in FIG. 13.

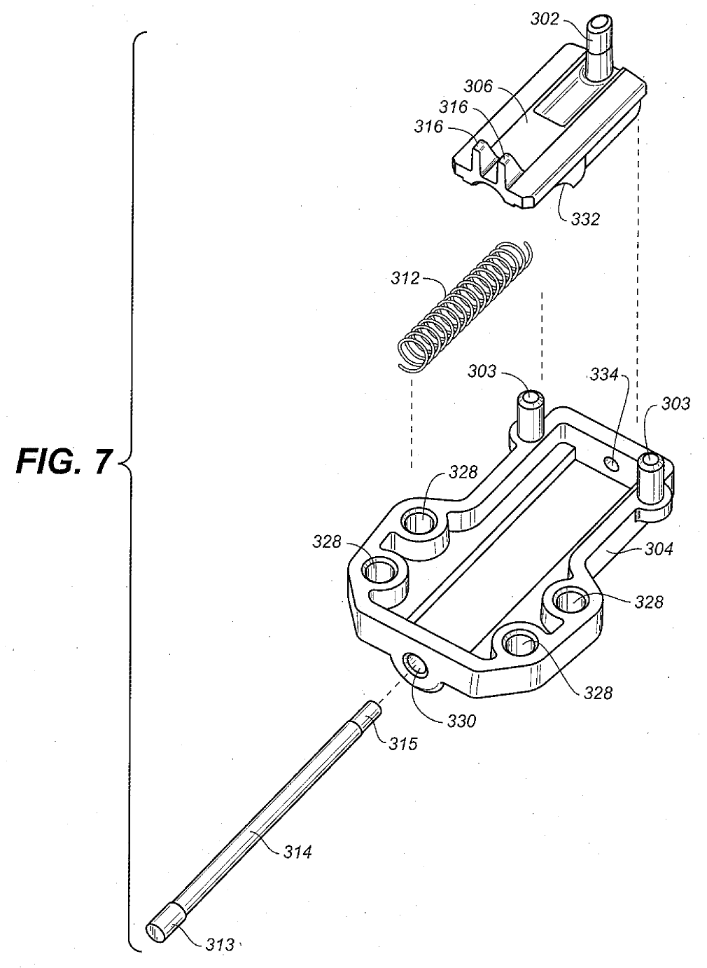

FIG. 7 shows an unassembled perspective view of lower portion 304 that includes a beam 314 and a biasing member, which is in the form of a spring 312. Beam 314 includes a distal beam portion 313 and a proximal beam portion 315. Lower portion includes a distal beam binder hole 330 and a proximal beam binder hole 334. Beam 314 may be rigidly mounted to lower portion 304 by mounting proximal beam portion 315 to proximal beam binder hole 334 and attaching distal beam portion 313 to a distal beam binder hole 330. Distal beam portion 313 can be bound to distal beam binder hole 330 using a threaded mechanical arrangement. Spring 312 may be concentrically mounted around beam 314 before mounting beam 314 to lower portion 304. Pusher assembly 306 can include a biasing member stop 332 that is configured to push against one end of spring 312. The other end of spring 312 can push against an inner wall portion of lower portion 304 that is nearby proximal beam binder hole 330, as illustrated in FIGS. 6 and 7. Spring 312 may become compressed when slideable ejection button 201 is actuated via actuation post 302 for ejecting test strip 100. After the ejection process, spring 312 becomes uncompressed causing pusher assembly 306 to go back to its initial state.

In FIGS. 6 and 7, pusher assembly 306 is illustrated as being floatably attached to housing 204 that causes ejection mechanism 300 to be robust to damage that can result from dropping. More specifically, pusher assembly 306 is not rigidly constrained to lower portion 304 and is slidably engage with rod 314 and guiding slots (320, 326) of PCB 18. However, rod 314 and PCB 18 are rigidly constrained to lower portion 304, which are in turn bound to housing 204.

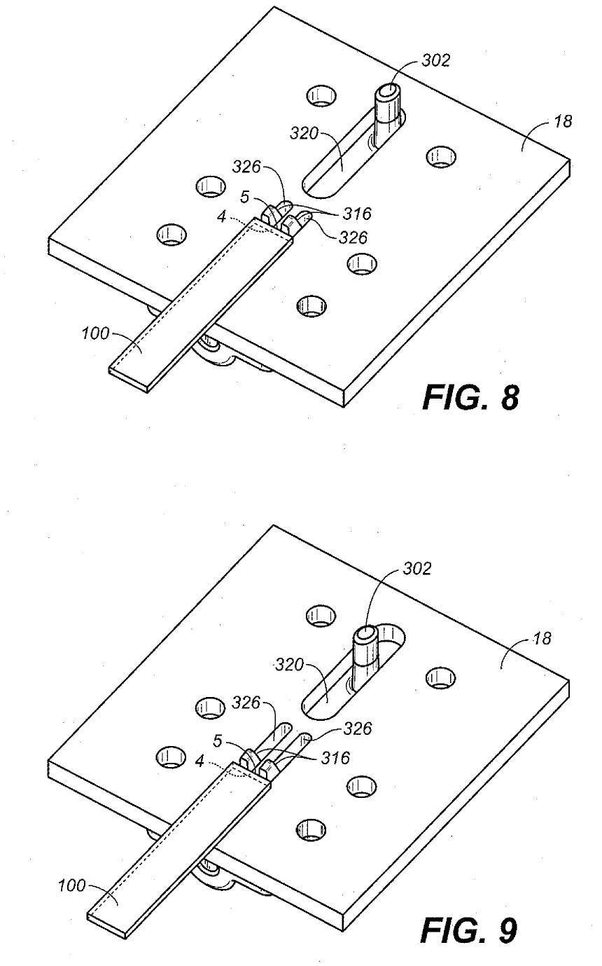

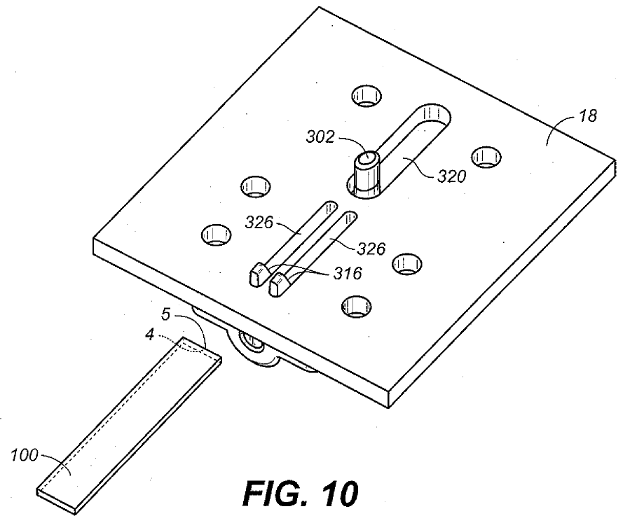

The following will describe how the test strip ejection mechanism 300, as illustrated in FIG. 6, is configured so that pusher assembly 306 does not touch test strip connector (101, 102, or 103) during the ejection process. Pusher assembly 306 should not touch test strip connector (101, 102, or 103) because a deformation can prevent an electrical connection with a subsequent test strip 100. Pusher assembly 306 includes two fins 316 and an actuation post 302, as illustrated in FIGS. 6 and 7. The two fins 316 are configured to push against proximal end 4 of test strip 100 during the ejection process, as illustrated in FIGS. 8 to 10. Actuation post 302 is operatively connected to ejection button 201 so that a slideable movement of ejection button 201 also causes a corresponding movement of actuation post 302 (not shown).

Fin 316 may also be in the form of a rib, a protrusion, or an appendage that allows a mechanical pushing of test strip 100 out of test meter 200. Although the two fins 316 are used in the embodiment shown in FIG. 7, pusher assembly 306 may be configured to have one or more fins for ejecting a test strip. The fin(s) can be arranged on pusher assembly 306 so that a substantially symmetrical force is applied to proximal end 4 of test strip 100 for allowing an ejection to occur in a substantially linear manner.

Actuation post 302 is slidably actuated to move in a same direction as an ejected test strip 100, as illustrated in FIGS. 8 to 10. To help guide actuation post 302 during a deployment process, PCB 18 is keyed to have a corresponding guiding slot 320 for helping provide a substantially linear motion, as illustrated in FIGS. 8 to 10. To help guide the two fins 316 during the deployment process, PCB 18 is also keyed to have two corresponding guiding slots 326 for helping provide a substantially linear motion, as illustrated in FIGS. 8 to 10.

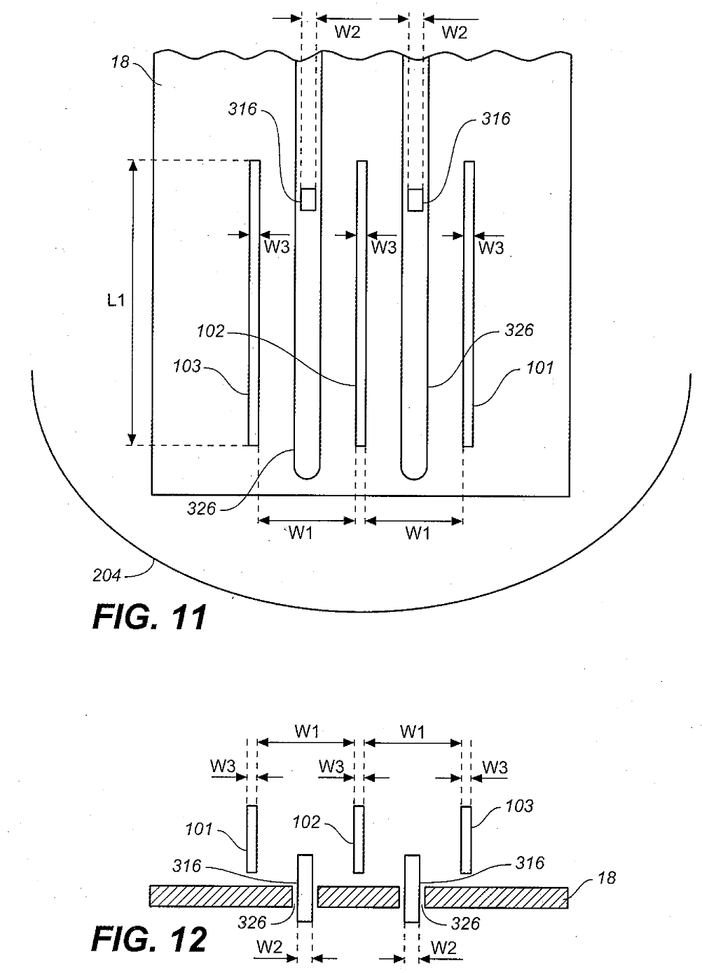

In addition to helping facilitate a substantially linear motion, the two guiding slots 326 help ensure that the two fins 316 do not touch test strip connectors (101, 102, or 103), as illustrated in FIGS. 11 and 12. A simplified top view and a simplified side view in FIGS. 11 and 12, respectively, illustrate the test strip connectors (101, 102, 103) with respect to the position of the two guiding slots 326 and the two fins 316. The two fins 316 are configured to push in between adjacent test strip connectors (101, 102, 103), as illustrated in FIGS. 11 and 12. First connector 103, second, connector 102, and reference connector 101 are orientated in a spaced apart manner having a separation width W1 that may range from about 1.5 millimeters to about 2.0 millimeters. The two fins 316 have a width W2 that is smaller than the separation width W1, as illustrated in FIGS. 11 and 12.

Pusher assembly 306 can propel test strip 100 without manipulating an orientation of test meter 200 even though pusher assembly 306 does not extend beyond an exterior portion of housing 204 when fully deployed. FIG. 11 illustrates that the two fins 316 of pusher assembly 306 do not extend beyond housing 204. Therefore, test strip ejection mechanism 300 must be able to provide a sufficient amount of propulsion force so that test strip 100 can be fully ejected from test meter 200.

In an embodiment of the present invention, the test strip connectors (101, 102, 103) can be adapted to impart a propulsion force to test strip 100 sufficient to clear housing 204, as is illustrated in FIGS. 13 to 16. However, the propulsion force should not be so large that a user cannot conveniently aim the test strip trajectory into a waste receptacle. In one embodiment, an upper boundary of the propulsion force may be defined as being a force that causes test strip 100 to be propelled less than about an 18 centimeter distance from the exterior of housing 204 when test meter 200 is elevated about 11 centimeters above a surface. It should be noted that in the embodiment described here that the two strip-in-place connectors 104 do not contribute to the propulsion force of an ejected test strip.

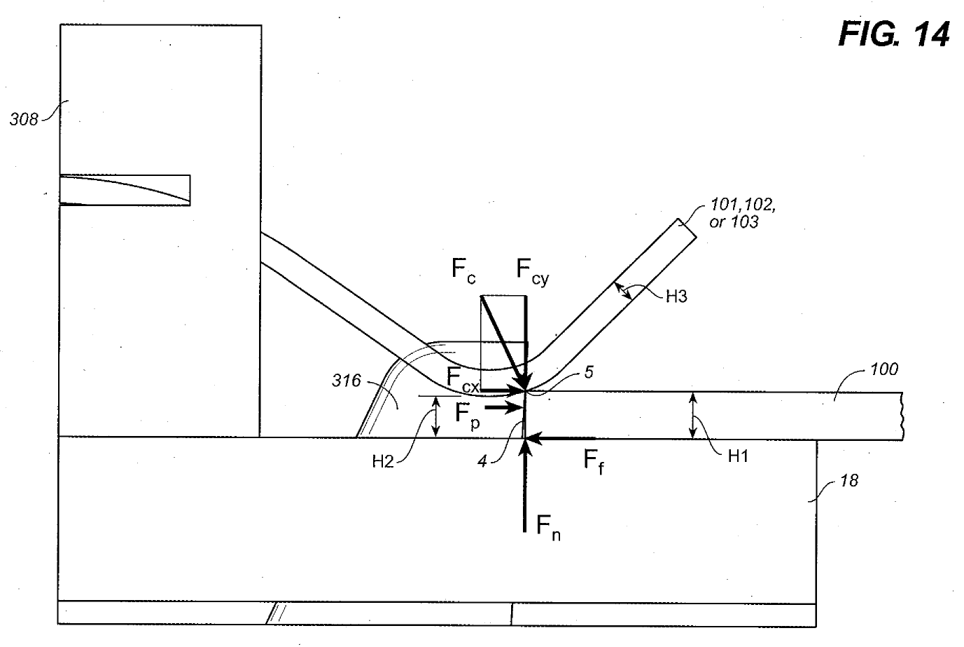

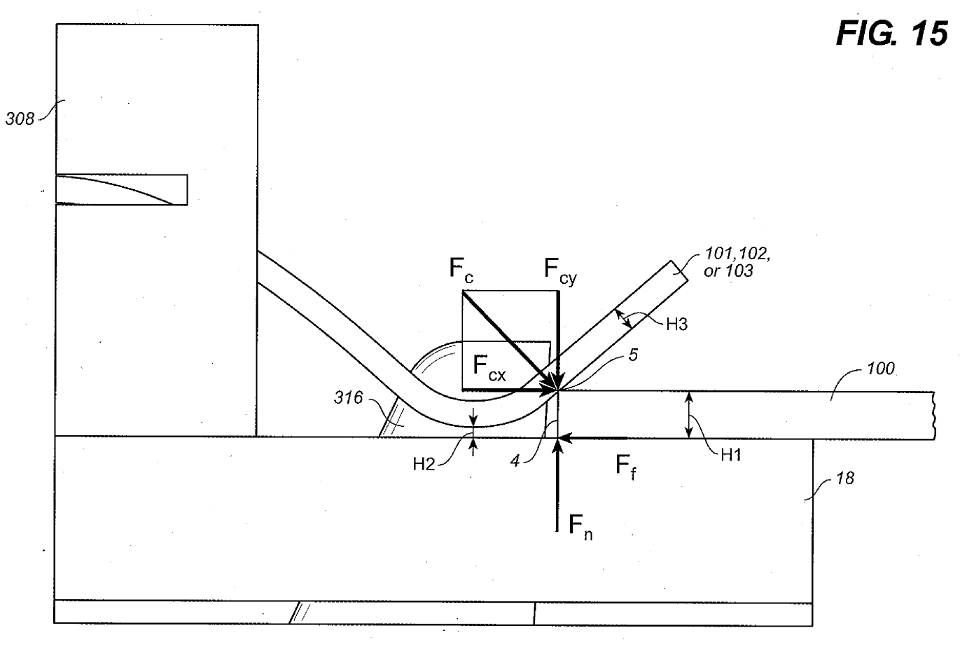

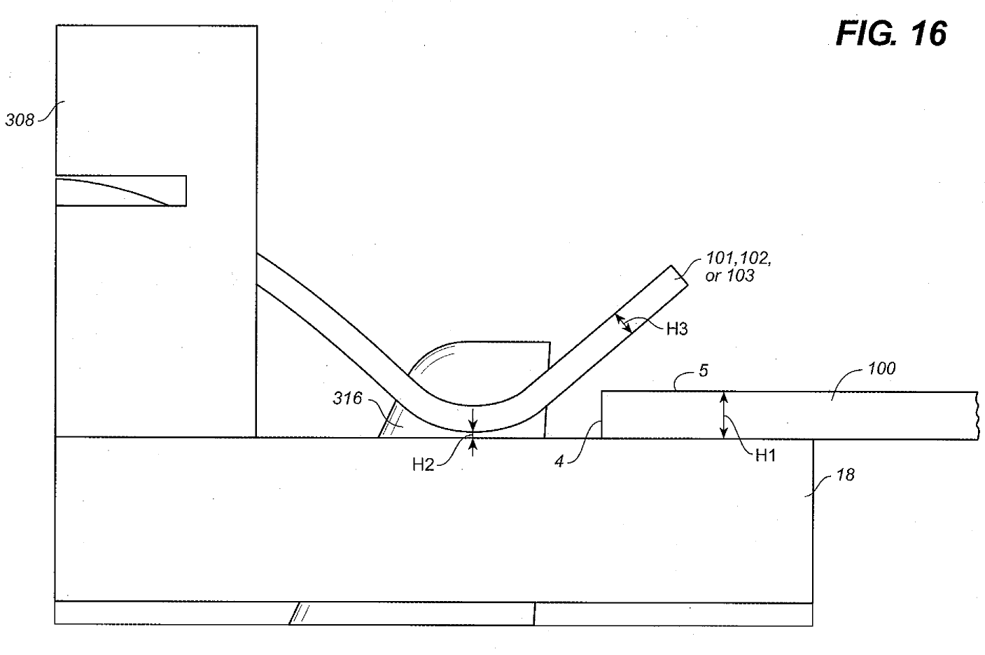

FIGS. 13 to 16 illustrate a simplified side cross-section view of four different states of test strip ejection mechanism 300. The four different states each represent a snapshot of the ejection process when moving ejection button 201 from an initial position to a fully deployed position. In the first state, ejection button 201 has been moved to a first position where fin 316 has started to touch proximal end 4 of test strip 100, as illustrated in FIG. 13. In the second state, ejection button 201 has been moved to a second position causing fins 316 to advance test strip 100 to a point where the test strip connectors (101, 102, 103) are in contact with a top proximal edge 5, as illustrated in FIG. 14. The top proximal edge 5 is a line formed by a vertex of a planar portion of proximal end 4 and a top planar portion of test strip 100, as illustrated in FIG. 14. In the third state, ejection button 201 has been moved to a third position causing fins 316 to further advance test strip 100 so that test strip connectors (101, 102, 103) can snap over top proximal edge 5, as illustrated in FIG. 15. The act of snapping over top proximal edge 5 causes an outward propulsion force to be applied. In the fourth state, ejection button 201 has been moved to a fourth position where test strip mechanism has been fully deployed and test strip 100 is in free flight, as illustrated in FIG. 16.

The following will describe the forces that are applied to test strip 100 during the four different states of the ejection mechanism. In the first state, the test strip connectors (101, 102, 103) apply a connector force F_{c} to a top portion of test strip 100, as shown in FIG. 13. The connector force F_{c} is a result of a reflexive relaxation of the test strip connectors (101, 102, 103). In the first state, the inserted test strip 100 has caused the test strip connector (101, 102, 103) to be a distance from PCB 18, which in this state is coincident with a test strip height H1, as illustrated in FIG. 13. A portion of the test strip connectors (101, 102, 103) that touches against test strip 100 has a curved shape, as illustrated in FIG. 13. A normal force Fₙ is exerted by PCB 18 with a magnitude that neutralizes connector force F_{c}. In the first state, connector force F_{c} should be sufficient to immobilize test strip 100 to PCB 18 in a secure manner and also to provide for robust electrical connection to the test strip contact pads (11, 13, 15). In the first state, the downward connector force F_{c} applied to test strip 100 by test strip connectors (101, 102, 103) may range from about 0.36 Newtons to about 0.84 Newtons.

In the first state, fins 316 can apply a pusher force Fₚ against proximal end 4 of test strip 100, as illustrated in FIG. 13. In order for test strip 100 to be moved outward from test meter 200, the pusher force Fₚ should be greater than the frictional force F_{f}. It should be noted that a magnitude of the frictional force F_{f} is proportionally based on the downward connector force F_{c} and a coefficient of friction between test strip 100 and PCB 18. In addition, the magnitude of the frictional force F_{f} can also include a coefficient of friction between test strip 100 and the test strip connectors (101, 102, 103).

In contrast to the first state, connector force F_{c} is not perpendicular to the plane of PCB 18 in the second state because the test strip connector (101, 102, 103) is applying a force to the proximal edge 5 as opposed to the top surface of test strip 100, as illustrated in FIG. 14. It should be noted that the direction of the connector force F_{c} is perpendicular to a tangential line at the point of contact with test strip 100. Because test strip connectors (101, 102, 103) are curved, the tangential line is no longer parallel with the top surface of test strip 100 when test strip 100 is moved to the second position, as illustrated in FIG. 14. The connector force F_{c} can also be described as a superposition of two connector forces F_{cx}, which is parallel to a plane of PCB 18, and F_{cy}, which is perpendicular to the plane of PCB 18.

In the second state as illustrated in FIG. 14, test strip connectors (101, 102, 03) are applying a connector force F_{cx}, but it is not yet sufficient to eject test strip 100. As mentioned earlier, connector force F_{cx} must be greater than frictional force F_{f} to eject test strip 100. It should be noted that the frictional force F_{f} has decreased in the second state when compared to the first state because of a decreased connector force F_{cy} in the y-direction. During the second state, a height H2, which is a distance between PCB 18 and the test strip connector (101, 102, 103), becomes smaller than test strip height H1 as a result of a partial relaxation of test strip connector (101, 102, 103).

In the third state of the test strip ejection mechanism, the test strip connectors (101, 102, 103) apply a connector force F_{cx} sufficient to overcome the frictional force F_{f}, as illustrated in FIG. 15. The third state represents a transitional state where test strip connectors (101, 102, 103) are in the process of snapping over a top proximal edge 5 to generate a sufficiently large connector force F_{cx} to eject test strip 100. During the third state, test strip 100 is further moved along test strip ejection mechanism 300 so that the height H2 decreases when compared to the second state because of a continued relaxation of the test strip connectors (101, 102, 103).

In the fourth state of the test strip ejection mechanism, test strip 100 is in free flight from test meter 200. FIG. 16 shows that fin 316 has been fully deployed, which enabled the test strip connectors (101, 102, 103) to apply a sufficient propulsion force to eject test strip 100 in a manner that did not require a user to manually touch test strip 100. After ejecting test strip 100, the height H2 represents a free standing position of test strip connector (101, 102, 103) with respect to PCB 18. Note that the free standing test strip connector height H2 may also be referred to as a minimum gap distance.

The following will describe factors that influence the magnitude of the test strip connector force F_{c}, which in turn also influences the test strip ejection distance. The test strip connector force F_{c} can be quantified as a product of a spring rate of the test strip connector (in units of N/mm) and the deflection of a test strip connector (in units of mm) produced by the interference between the test strip connector and the test strip 100. Thus, the spring rate of the test strip connector and the deflection of the test strip connector both influence the magnitude of the test strip connector force F_{c}.

The spring rate of the test strip connector, which is one factor that can influence the test strip connector force F_{c}, can be a function of a modulus of elasticity of the test strip connector material (e.g., phosphor bronze), a test strip connector thickness H3 (see FIGS. 13 to 16), a test strip connector width W3 (see FIGS. 11 and 12), and a test strip connector length L1 (see FIG. 1). The spring rate of the test strip connectors can be more sensitive to the test strip connector thickness H3 than the test strip connector width W3 and the test strip connector length L1 because the spring rate varies with the cube of the test strip connector thickness H3. In one embodiment, the test strip connector thickness H3 may range from about 0.19 mm to about 0.21 mm, and preferably be about 0.2 mm. Using a test strip connector thickness H3 of 0.2 mm with a possible variation of +/−0.1 mm, a test strip connector force F_{c} may vary from about +/−15%.

The deflection of the test connector is another factor that influences the test strip connector force F_{c}. The deflection can be represented by a difference between the test strip height H1 and a free standing test strip connector height H2. An example of the free standing test strip connector height H2 is shown in FIG. 16 where the test strip connector (101, 102, 103) has the height H2 with respect to PCB 18 without an inserted test strip. The test strip connectors (101, 102, 103) may be configured to have a free standing test strip connector height H2 ranging from about 0 millimeters to about 0.2 millimeters, and preferably between about 0.1 millimeters to about 0.2 millimeters. The test strip height H1 may range from about 0.335 millimeters to about 0.365 millimeters. Accordingly, the test strip connector may be deflected a distance ranging from about 0.135 millimeters to about 0.365 millimeters, and preferably between about 0.135 millimeters and 0.355 millimeters. Alternatively, the test strip connectors (101, 102, 103) may be configured to have a free standing test strip connector height H2 ranging from about 0% to about 60% of a test strip height H1, and preferably ranging from about 30% to about 60% of the test strip height H1.

The deflection of the test strip connector can be configured to be a relatively constant value for a large population of manufactured test meters so as to reduce variability between test meter-to-test meter for the ejection distance. The free standing test strip connector height H2 and the test strip height H1 are two factors that can influence the test meter-to-test meter variability when manufacturing large numbers of test meters 200 having test strip ejection mechanism 300. In general, the free standing test strip connector height H2 was found to have more variability than the test strip height H1. For example, a free standing test strip connector height H2 of 0.05 mm may cause a test strip ejection distance of about 15 cm whereas a free standing test strip connector height H2 of 0.2 mm may cause a test strip ejection distance of about 8 cm. Accordingly, the following will describe methods for modifying test strip connectors so that the free standing test connection height H2 has a reduced variability when making a large number of test strip connectors.

The free standing test strip connector height H2 can be tailored to be within a pre-determined range so as to maintain a relatively low amount of test meter-to-test meter variation in regards to the ejection distance. Further, the pre-determined range can be tailored so that all manufactured test meters would have a test strip ejection distance that does not exceed a pre-determined upper limit. For example, the free standing test strip connector height H2 may range from about 0.1 mm to about 0.2 mm that causes a corresponding test strip ejection distance ranging from about 12 centimeters to about 8 centimeters.

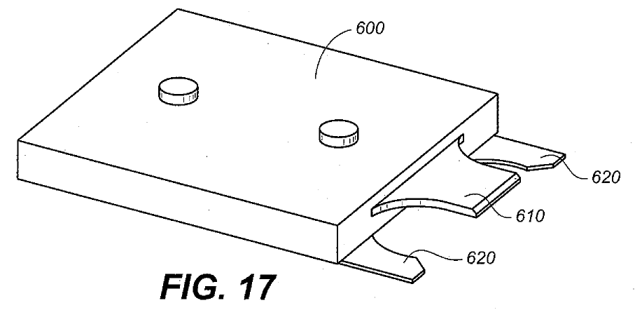

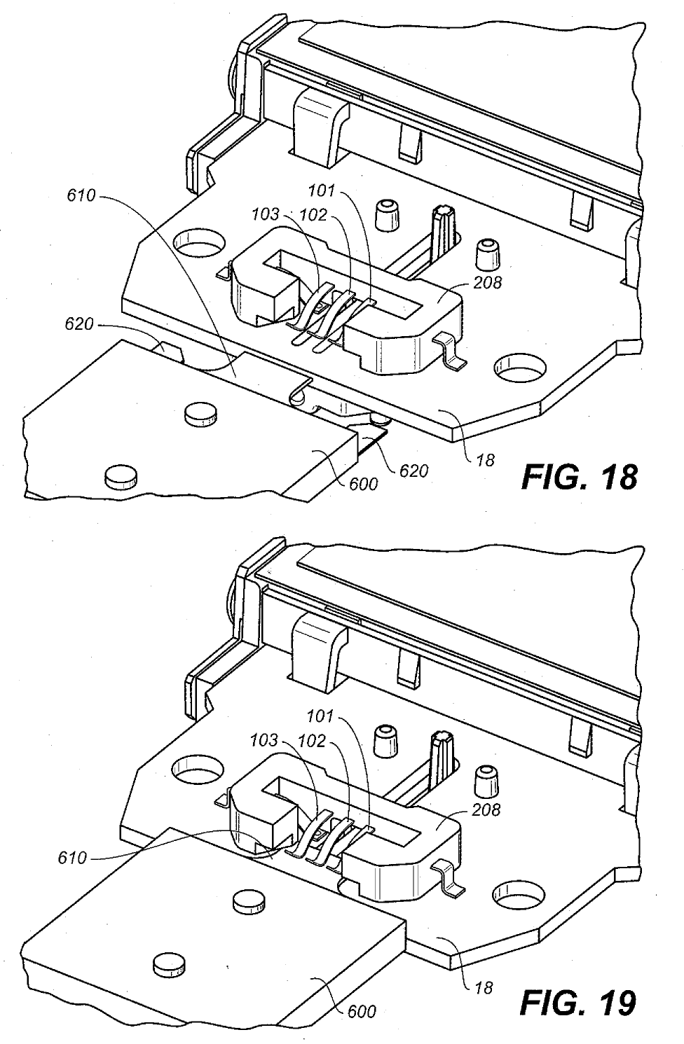

In an embodiment of the present invention, a method for reducing variation in the free standing test strip connector height H2 can include using a shim 600, as illustrated in FIGS. 17 to 19. In this embodiment, the test strip connectors (101, 102, 103) are reformed so that the free standing test strip connector height H2 is increased to be within a pre-determined range. FIGS. 18 and 19 illustrate the process of reforming the free standing test strip connector height H2 using shim 600. Shim 600 can be inserted into the test strip connectors (101, 102, 103) so that they are flexed in a first direction to a predetermined height coincident with a height of the shim. Next, shim 600 can be removed from the test strip connectors (101, 102, 103) allowing a relaxation to occur in a second direction that opposes the first direction. After removing shim 600, the free standing test strip connector height H2 will be increased to a predetermined value based on the height of shim 600. The test meter-to-test meter variation with respect to the test strip eject distance will be decreased by configuring a predetermined range for the free standing test strip connector height H2. In one embodiment, the free standing test strip connector height H2 may range from about 0.1 millimeters to about 0.2 millimeters.

FIG. 17 illustrates an embodiment of shim 600 that can be used for the process of reforming the free standing test strip connector height H2 when inserting a proximal portion 610 into strip port connector 208. The proximal portion 610 and a guiding portion 620 can interface with an upper surface and lower surface of PCB 18 to guide the insertion of shim 600. Shim 600 should have a height greater than the initial free standing test strip connector height H2 so that the test strip connector will be flexed upwards.

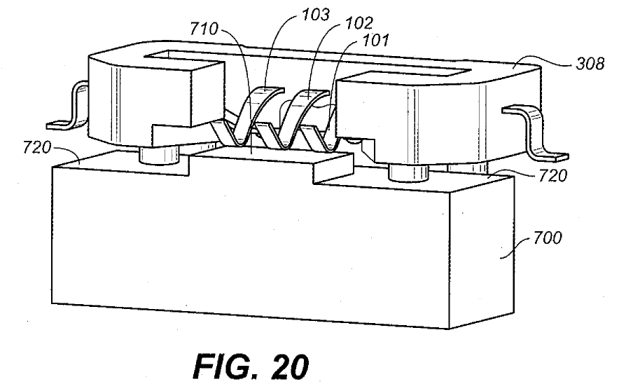

In an alternative embodiment of the present invention, a method for reducing the variation in the free standing test strip connector height H2 can include mating a reforming fixture 700 with upper portion 308, as illustrated in FIG. 20. Reforming fixture 700 can be used to reform and permanently increase the free standing test strip connector height H2. Reforming fixture 700 includes an upper step 710 and a lower step 720, as illustrated in FIG. 20. Upper step 710 can be configured to push against the test strip connectors (101, 102, 103) and lower steps 720 can be configured to push against lower posts 310 for use as a guide. Lower posts 310 may also be referred to as a lower portion of a bracket configured to hold the test strip connectors (101, 102, 103). The process of mating reforming fixture 700 causes test strip connectors (101, 102, 103) to move upwards from a first position to a second position. Removing reforming fixture 700 causes the test strip connector (101, 102, 103) to relax to a third position that is upwards from the first position. Next, PCB 18 is attached so that a free standing test strip connector height H2 is formed between the test strip connector (101, 102, 103) and PCB 18. The free standing test strip connector height H2 may range from about 0.1 millimeters to about 0.2 millimeters.

In an embodiment of the present invention, a method for ejecting test strip 100 can include a user inserting proximal end 4 of test strip 100 into strip port connector 208. The test strip connectors can apply a force F_{c} to hold test strip 100 in place. The user can perform a glucose test by applying a blood sample 94 to inlet 90 of test strip 100. A resulting glucose concentration can then be shown on visual display 202. Once the test is completed, ejection button 201 can be actuated causing pusher assembly 306 to be deployed. Pusher assembly 306 via the two fins 316 can push in between test strip connectors (101; 102, 103) and against proximal end 4 of test strip 100 while the test strip connectors touch a top surface of test strip 100. Pusher assembly 306 applies a pusher force Fₚ via the two fins 316 that is greater than a frictional force F_{f}, to cause movement of test strip 100.

The test strip connectors (101, 102, 103) will apply a test strip connector force F_{c} substantially perpendicular to the top surface of test strip 100 when the test strip connector (101, 102, 103) touches a top surface of test strip 100, but does not touch top proximal edge 5. The test strip connector force F_{c} may range from about 0.36 Newtons to about 0.84 Newtons.

During the process of deploying pusher assembly 306, the test strip connectors (101, 102, 103) transition from touching the top surface of test strip 100 to touching top proximal edge 5, which allows the test strip connectors (101, 102, 103) to snap over top proximal edge 5 and eject test strip 100. When the test strip connectors transition from the top surface to top proximal edge 5, test strip connectors start to apply an increasing amount of an outward forces F_{cx} and a decreasing amount of downward force F_{cy}. Test strip connectors (101, 102, 103) can eject test strip 100 when test strip connector force F_{cx} is greater than frictional force F_{f} without a user having to manipulate an orientation of test meter 200.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods within the scope of these claims and their equivalents be covered thereby.

What is claimed is:

1. A test strip ejection mechanism comprising:
a pusher assembly having at least one fin; and
a plurality of spaced apart test strip connectors configured to contact to a plurality of contact pads disposed on a test strip, wherein the at least one fin is configured to push in between adjacent test strip connectors and against a proximal end of the test strip until the test strip is ejected.

2. The test strip ejection mechanism of claim 1, wherein the plurality of spaced apart test strip connectors apply a force of a sufficient magnitude to substantially immobilize the test strip.

3. The test strip ejection mechanism of claim 1, wherein a deployment of the pusher assembly causes the plurality of spaced apart test strip connectors to snap over a proximal top edge of the test strip during an ejection.

4. The test strip ejection mechanism of claim 3 further comprising a housing configured to substantially enclose the test strip ejection mechanism, wherein the pusher assembly does not extend beyond an exterior of the housing when deployed.

5. The test strip ejection mechanism of claim 4, wherein the test strip is propelled a distance of less than about 18 centimeters when the test strip ejection mechanism is elevated about 11 centimeters.

6. The test strip ejection mechanism of claim 4, wherein the test strip can be ejected without manually manipulating an orientation of the test strip ejection mechanism for facilitating an ejection.

7. The test strip ejection mechanism of claim 2, wherein the force ranges from about 0.36 Newtons to about 0.84 Newtons.

8. The test strip ejection mechanism of claim 1 further comprising a lower portion and an upper portion, the plurality of spaced apart test strip connectors being disposed on the upper portion, and the pusher assembly being disposed on the lower portion.

9. The test strip ejection mechanism of claim 1 further comprising a substantially planar portion disposed in between the upper portion and the lower portion, the substantially planar portion having at least one slot configured to guide the at least one fin in between adjacent test strip connectors.

10. The test strip ejection mechanism of claim 9, wherein the plurality of spaced apart test strip connectors are configured to have a minimum gap distance with respect to the substantially planar portion, wherein the minimum gap ranges from about 0% to about 60% of a test strip height.

11. The test strip ejection mechanism of claim 9, wherein the plurality of spaced apart test strip connectors are configured to have a minimum gap distance with respect to the substantially planar portion, wherein the minimum gap ranges from about 30% to about 60% of a test strip height.

12. The test strip ejection mechanism of claim 9, wherein the plurality of spaced apart test strip connectors are configured to have a minimum gap distance with respect to the substantially planar portion, wherein the minimum gap ranges from about 0.1 millimeters to about 0.2 millimeters.

13. The test strip ejection mechanism of claim 9, wherein the substantially planar portion is a printed circuit board.

14. The test strip ejection mechanism of claim 1, wherein the pusher assembly has two fins configured to travel in between three adjacent test strip connectors.

15. The test strip ejection mechanism of claim 1, wherein the pusher assembly is operatively attached to a slideable button configured to move in a same direction as the test strip during an ejection.

16. The test strip ejection mechanism of claim 15 further comprising a biasing member for returning the pusher assembly to an initial state after ejecting the test strip.

17. The test strip ejection mechanism of claim 1 wherein the pusher assembly is floatably attached to the housing.

18. A method of reforming a test strip connector comprising:
providing a test strip connector having a minimum gap distance from a substantially planar portion;
inserting a shim into the test strip connector so that the test strip connector is flexed in a first direction to a predetermined height coincident with a height of the shim; and
removing the shim from the test strip connector allowing the test strip connector to relax in a second direction that opposes the first direction, wherein the minimum gap distance increases to a predetermined value after removing the shim compared to the minimum gap distance before inserting the shim.

19. The method of claim 18, wherein the shim has a predetermined height greater than the minimum gap distance before inserting the shim.

20. The method of claim 18, wherein the minimum gap distance after inserting the shim ranges from about 0.1 millimeters to about 0.2 millimeters.

21. A method of reforming a test strip connector comprising:
mating a reforming fixture with a test strip connector so that the test strip connector moves upwards from a first position to a second position, the reforming fixture having an upper step and a lower step, the upper step being configured to push upwards against the test strip connector and the lower step being configured to push upwards against a lower portion of a bracket, the bracket configured to hold the test strip connector;
removing the reforming fixture so that the test strip connector relaxes to a third position that is upward from the first position; and
attaching a substantially planar portion to the bracket so that a minimum gap distance is formed between the test strip connector and the substantially planar portion.

22. The method of claim 21, wherein the minimum gap distance ranges from about 0.1 millimeters to about 0.2 millimeters.

23. A method for ejecting a test strip comprising:
actuating an ejection button that causes a pusher assembly to be deployed, the pusher assembly having at least one fin;
moving the at least one fin in between a plurality of test strip connectors;
pushing against a proximal end of the test strip with the at least one fin in an outward direction from a test meter while the test strip connectors touches a top surface of the test strip;
continuing to advance the proximal end so that the test strip connectors touches a top proximal edge of the test strip; and
snapping the test strip connectors over the top proximal edge of the test strip so that the test strip is ejected.

24. The method of claim 23, wherein the test strip connectors apply a test strip connector force substantially perpendicular to the top surface of the test strip when the test strip connector touches the top surface and does not touch the top proximal edge.

25. The method of claim 24, wherein the test strip connector force ranges from about 0.36 Newtons to about 0.84 Newtons

26. The method of claim 23, wherein the pusher assembly applies a pusher force via the at least one fin that is greater than a frictional force, the frictional force being proportional to a product of the test strip connector force that is substantially perpendicular to the top surface and a coefficient of friction between the test strip and the substantially planar portion.

27. The method of claim 23, wherein the test strip connector applies a test strip connector force in an outward direction from the test meter when the test strip connector touches the top proximal edge of the test strip.

28. The method of claim 27, wherein the test strip connector applies a test strip connector force sufficient to propel the test strip in an outward direction from the test meter when the outward test strip connector force is greater than an opposing frictional force.
